(19) United States
(12) Patent Application Publication
(10) Pub. No.: US 2019/0034684 A1
(43) Pub. Date: Jan. 31, 2019

(54) METHOD AND SYSTEM FOR QUANTIFYING DAMAGED QR CODES

(71) Applicant: FUJIAN LANDI COMMERCIAL EQUIPMENT CO., LTD, Fuzhou, Fujian (CN)

(72) Inventors: Weijian XIAO, Fuzhou, Fujian (CN); Kui LIN, Fuzhou, Fujian (CN)

(73) Assignee: FUJIAN LANDI COMMERCIAL EQUIPMENT CO., LTD, Fuzhou, Fujian (CN)

(21) Appl. No.: 16/073,775

(22) PCT Filed: Aug. 12, 2016
(86) PCT No.: PCT/CN2016/094804

§ 371 Date: Jul. 28, 2018

(30) Foreign Application Priority Data
Jun. 27, 2016 (CN) 201610476212.6

(51) Int. Cl. G06K 7/14; G06K 19/06

(52) U.S. Cl. CPC G06K 7/1473; G06K 7/1417; G06K 19/06037

(57) ABSTRACT

The present invention relates to a method and system for quantitative defacing of a QR Code. Defacing of the method includes data and error correction code word defacing, boundary defacing, position detection pattern defacing, correction pattern defacing, positioning pattern defacing, version information defacing, and format information defacing. Quantitative defacing varies with the defacing patterns and positions of a barcode. The defacing degree of the QR Code is not greater than the capability of the barcode for correcting error codes. The number of coding characters of the QR Code is required to be equal to the character number of a data code word which is specified by a current barcode version and correction grade, and the situation of adding filling characters does not exist. Defacing of the data and error correction code words does not include defacing of remaining bits. Defacing patterns include pre-stage printing defacing and rear-stage actual defacing. The present invention helps solve problems of failure in quantitative evaluation on defaced barcode defacing performance of a scanner, large labor cost in test, and unrepresentative test result.

### BACKGROUND OF THE INVENTION

### 1. Technical Field

The present invention relates to a method and system for quantitative defacing of a QR Code.

### 2. Description of Related Art

In the barcode scanning field, sometimes barcodes to be scanned are defaced. Defacing forms include barcode contamination, barcode damage, barcode wrinkling, and fading and fuzzy barcodes. The nature of the defacing forms is damage to white and black modules in the barcode, so that a scanner fails to identify the reflectivity of the current modules and therefore fails to decode the barcode. Whether the scanner can scan the defaced barcode or not is determined by two factors, namely the data correction capability of the barcode and the scanning algorithm of the scanner. At present, there is no systematic method for quantitative evaluation of the defaced barcode scanning capability of a scanner on the market.

On the other hand, the defaced positions of barcodes are random on the market. Scanner manufacturers fail to simulate real defaced patterns. Scanning a lot of defaced barcode samples one by one consumes a lot of labor, and test results are not representative. Therefore, the above problems are the study object of the present invention.

### BRIEF SUMMARY OF THE INVENTION

The present invention makes improvement aiming at problems in the prior art, which means that the technical problem to be solved by the present invention is to provide a method and system for quantitative defacing of a QR Code, which help solve the problems of failure in quantitative evaluation of defaced barcode scanning performance of a scanner, large labor cost in test, and failure to obtain representative test results.

To solve the above mentioned problems, the present invention employs the following technical solution:

A method for quantitative defacing of a QR Code, comprises the following steps:

S1: setting a version of a to-be-defaced QR Code and an error correction grade, calculating the number of data code words and the number of error correction code words of the barcode under the conditions of the current version and the current error correction grade;

S2: setting the coding character type of the to-be-defaced QR Code, calculating the maximum number of characters capable of being coded using the current character, type, which means that the number of bits of a data code word, after having added with the digits of a coded pattern indicator and the digits of a character counting indicator, is smaller than the number of the digits of a data code word under the conditions of the current version and correction grade; coding with the maximum number of characters to avoid the existence of filling characters in the data code word;

S3: generating the QR Code under the set conditions, dividing zones for various functional pattern modules and coding zone modules, wherein the modules include a data code word and error correction code word module, a barcode boundary module, a position defection pattern module, a correction pattern module, a positioning pattern module, a version information module, and a format information module;

S4: performing quantitative defacing on various modules respectively, wherein the quantitative defacing includes data and error correction code word defacing, boundary defacing, position detection pattern defacing, correction pattern defacing, positioning pattern defacing, version information defacing, and format information defacing.

In one embodiment of the present invention, the number of characters used for coding, in patterns including number patterns, letter-number patterns, and 8-byte patterns, is required to be equal to the number of characters corresponding to a data code word which is specified by the current version and correction grade to avoid the situation of adding filling characters.

In one embodiment of the present invention, the coding pattern of the QR Code is analyzed; defacing of the data and error correction code words of the QR Code is quantified; 8 data bits of each one of the data code words and each one of the correction code words are randomly defaced; and when a reading error appears at any one or more of the 8 data bits, it is determined that a substitution error has occurred to the current data code word or error correction code word.

in one embodiment of the present invention, the number of substitution errors of the current QR Code corresponding to the current version and correction grade is queried to ensure that the defacing degree of the data and error correction code words does not exceed the capacity of the QR code for correcting the error code words.

In one embodiment of the present invention, the defacing of the data and error correction code words does not include defacing of the remaining bits of the QR Code.

In one embodiment of the present invention, the defacing rate of the data and error correction code words of the current QR Code is equal to the product of the defaced code word module/(the number of data correction words+the number of correction code words)*100%.

In one embodiment of the present invention, barcode boundary blank zones of the barcode boundary module respectively correspond to 0, 1, 2, 3, 4 unit(s) of module widths, and the defacing of the barcode boundary module is divided into a total of 5 grades.

In one embodiment of the present invention, defacing of the position detection pattern module includes defacing of a single position detection pattern in an upper left corner, defacing of a single position detection pattern in a lower left corner, defacing of a single position defection pattern in an upper right corner, and simultaneous defacing of two or three of the position detection patterns; defacing of the correction pattern module is classified into defacing of a single correction pattern and simultaneous defacing of multiple correction patterns according to the number of correction patterns of the QR Code; defacing of the positioning pattern module is classified into defacing of a vertical positioning pattern, defacing of a horizontal positioning pattern, and simultaneous defacing of two positioning patterns; defacing of the version information module is classified into defacing of version information in a lower left corner, defacing of version information in a lower right corner, and defacing of two pieces of version information; and defacing of the format version module is classified into defacing of format information at a lower left corner and an upper right corner, and defacing, of format information at the left upper corner.

In one embodiment of the present invention, defacing of respective modules simulates the actual defacing situations to the maximum extent, and respective modules are defaced in a way of completely contaminating respective modules into light modules or dark modules of the barcode.

The present invention also provides a system for quantitative defacing of a QR Code, including:

a barcode manufacturing module, used for manufacturing a barcode with the minimum anti-defacing capability, wherein the number of coding characters is equal to the maximum character number corresponding to a data code word which is defined by the version information, correction grade, and coding characters of the barcode;

a barcode module zone dividing module, used for dividing module zones of the barcode to provide zone boundaries for quantitative defacing of all modules, wherein the modules include a data code word and error correction code word module, a barcode boundary module, a position detection pattern module, a correction pattern module, a positioning pattern module, a version information module, and a format information module;

a defacing pattern selection module, which provides pattern defacing options, namely a pre-stage priming defacing option and a rear-stage actual defacing option, wherein the pre-stage printing defacing refers to the operation of defacing a barcode when the barcode with the minimum anti-defacing capacity is manufactured and then printing the defaced barcode; the rear-stage actual defacing refers to the operation of printing a barcode with the minimum anti-defacing capability and then defacing a specific module zone by controlling a doodling pen manually or with a mechanical arm;

a defacing module, used for defacing all modules, wherein the defacing includes data and error correction code word defacing, boundary defacing, position detection pattern defacing, correction pattern defacing, positioning pattern defacing, version information defacing, and format information facing.

Compared with the prior art, the present invention has the following beneficial effects of quantitatively evaluating the scanning performance of defaced barcodes of the scanner, reducing the labor cost during testing, obtaining representative test results, positioning a certain stain with the largest influences on the barcode scanning performance by pertinence, thus improving the scanning performance of the scanner.

### BRIEF DESCRIPTION OF THE SEVERAL VIEWS OF THE DRAWINGS

FIG. 1 is an algorithm flowchart of an embodiment of the present invention;

FIG. 2 is a defacing model of data and error correction code words in an embodiment of the present invention.

FIG. 3 is a boundary defacing model in an embodiment of the present invention.

FIG. 4 is a position detection pattern defacing model in an embodiment of the present invention.

FIG. 5 is a correction pattern defacing model in an embodiment of the present invention.

FIG. 6 is a positioning pattern defacing model in an embodiment of the present invention.

FIG. 7 is a version information defacing model in an embodiment of the present invention.

FIG. 8 is a format information defacing model in an embodiment of the present invention.

FIG. 9 is a schematic view of zone division of respective modules of the present invention.

### DETAILED DESCRIPTION OF THE INVENTION

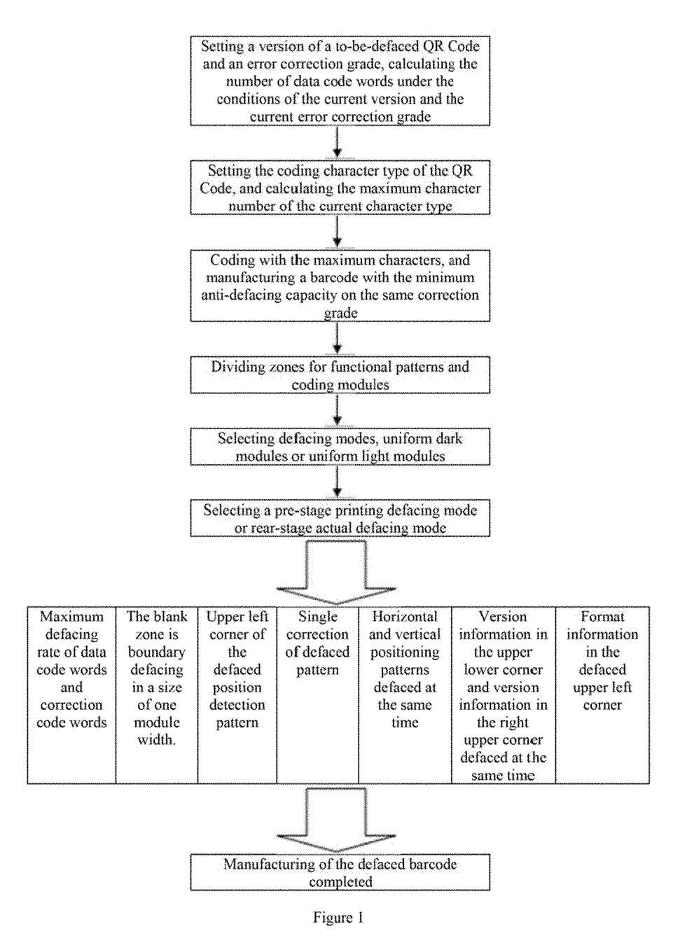

As shown in FIG. 1 and FIG. 9, the present invention provides a method for quantitative defacing of a QR Code, including the following steps:

S1: setting a version of a to-be-defaced QR Code and an error correction grade, calculating the number of data code words and the number of error correction code words of the barcode under the conditions of the current version and the current error correction grade;

S2: setting the coding character type of the to-be-defaced QR Code, calculating the maximum number of characters capable of being coded using the current character type, which means that the number of bits of a data code word, after having added with the digits of a coded pattern indicator and the digits of a character counting indicator, is smaller than the number of the digits of a data code word under the conditions of the current version and correction grade; coding with the maximum number of characters to avoid the existence of filling characters in the data code word;

S3: generating the QR Code under the set conditions, dividing zones for various functional pattern modules and coding zone modules, wherein the modules include a data code word and error correction code word module, a barcode boundary module, a position detection pattern module, a correction pattern module, a positioning pattern module, a version information module, and a format information module;

S4: performing quantitative defacing on various modules respectively, wherein the quantitative defacing includes data and error correction code word defacing, boundary defacing, position detection pattern defacing, correction pattern defacing, positioning pattern defacing, version information defacing, and format information defacing.

In one embodiment of the present invention, the number of characters used for coding, in patterns including number patterns, letter-number patterns, and 8-byte patterns, is required to be equal to the number of characters corresponding to a data code word which is specified by the current version and correction grade to avoid the situation of adding filling characters.

In one embodiment of the present invention, the coding pattern of the QR Code is analyzed; defacing of the data and error correction code words of the QR Code is quantified; 8 data bits of each one of the data code words and each one of the correction code words are randomly defaced; and when a reading error appears at any one or more of the 8 data bits, it is determined that a substitution error has occurred to the current data code word or error correction code word.

In one embodiment of the present invention, the number of substitution errors of the current QR Code corresponding to the current version and correction grade is queried to ensure that the defacing degree of the data and error correction code words does not exceed the capacity of the QR code for correcting the error code words.

in one embodiment of the present invention, the defacing of the data and error correction code words does not include defacing of the remaining bits of the QR Code.

In one embodiment of the present invention, the defacing rate of the data and error correction code words of the current QR Code is equal to the product of the defaced code word module/(the number of data correction words+the number of correction code words)*100%.

In one embodiment of the present invention, barcode boundary blank zones of the barcode boundary module respectively correspond to 0, 1, 2, 3, 4 unit(s) of module widths, and the defacing of the barcode boundary module is divided into a total of 5 grades.

In one embodiment of the present invention, defacing of the position detection pattern, module includes defacing of a single position detection pattern in an upper left corner, defacing of a single position detection pattern in a lower left corner, defacing of a single position defection pattern in an upper right corner, and simultaneous defacing of two or three of the position detection patterns; defacing of the correction pattern module is classified into defacing of a single correction pattern and simultaneous defacing of multiple correction patterns according to the number of correction patterns of the QR Code; defacing of the positioning pattern module is classified into defacing of a vertical positioning pattern, defacing of a horizontal positioning pattern, and simultaneous defacing of two positioning patterns; defacing of the version information module is classified into defacing of version information in a lower left corner, defacing of version information in a lower right corner, and defacing of two pieces of version information, and defacing of the format version module is classified into defacing of format information at a lower left corner and an upper right corner, and defacing of format information at the left upper corner.

In one embodiment of the present invention, defacing of respective modules simulates the actual defacing situations to the maximum extent, and respective modules are defaced in a way of completely contaminating respective modules into light modules or dark modules of the barcode.

The present invention also provides a system for quantitative defacing of a QR Code, including:

a barcode manufacturing module, used for manufacturing a barcode with the minimum anti-defacing capability, wherein the number of coding characters is equal to the maximum character number corresponding to a data code word which is defined by the version information, correction grade, and coding characters of the barcode;

a barcode module zone dividing module, used for dividing module zones of the barcode to provide zone boundaries for quantitative defacing of all modules, wherein the modules include a data code word and error correction code word module, a barcode boundary module, a position detection pattern module, a correction pattern module, a positioning pattern module, a version information module, and a format information module;

a defacing pattern selection module, which provides pattern defacing options, namely a pre-stage printing defacing option and a rear-stage actual defacing option, wherein the pre-stage printing defacing refers to the operation of defacing a barcode when the barcode with the minimum anti-defacing capacity is manufactured and then printing the defaced barcode; the rear-stage actual defacing refers to the operation of printing a barcode with the minimum anti-defacing capability and then defacing a specific module zone by controlling a doodling pen manually or with a mechanical arm;

a defacing module, used for defacing all modules, wherein the defacing includes data and error correction code word defacing, boundary defacing, position detection pattern defacing, correction pattern defacing, positioning pattern defacing, version information defacing, and format information facing.

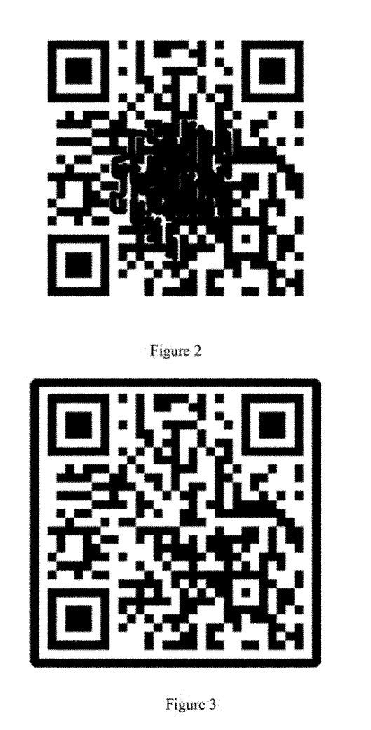

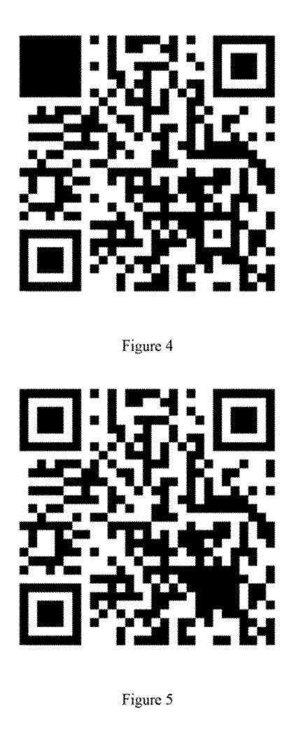

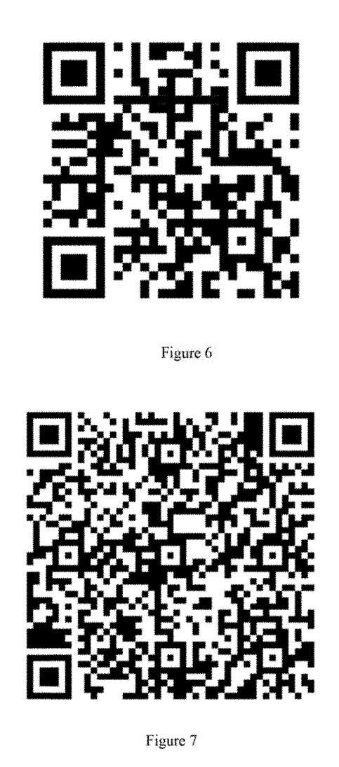

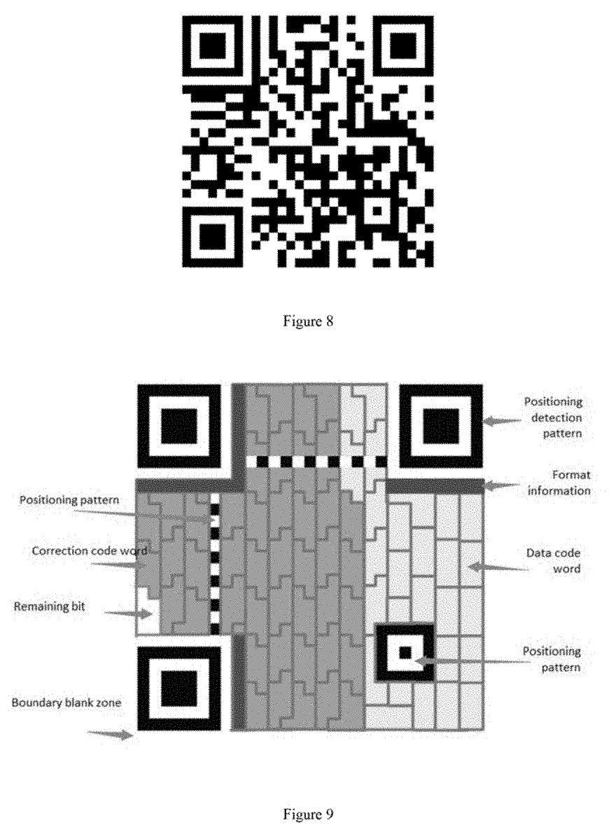

Embodiment I: As shown in FIG. 2-8, a method and system for quantitative defacing of a QR Code are provided. Defacing includes data and error correction code word defacing, boundary defacing, position detection pattern defacing, correction pattern defacing, positioning pattern defacing, version information defacing, and format information defacing.

In this embodiment, the defacing degree of data and error correction code words reaches the maximum value of the defacing capable of being corrected by a barcode, and is the maximum defacing rate of the data and error correction code words.

In this embodiment, a blank zone of boundary defacing is one module width, on the second grade of boundary defacing.

In this embodiment, a position defection pattern defacing model is the upper left corner detection pattern defacing module.

In this embodiment, a barcode in this version has only one correction pattern, so the defacing model is a single correction pattern defacing model.

In this embodiment, a positioning pattern defacing model is a defacing model where vertical and horizontal positioning patterns are defaced at the same time.

In this embodiment, the version information defacing model is a defacing model where the version information at the lower left corner and the version information at the upper right corner is defaced at the same time.

In this embodiment, the format information defacing model is the upper left corner format information defacing model.

Further, the defacing pattern in this embodiment refers to contaminating all modules of the barcode into dark modules.

The above are merely preferable embodiments of the present invention. All equivalent changes and modifications made in accordance with the patent scope of the present invention shall fall within the protective scope of the present invention.

What is claimed is:

1. A method for quantitative defacing of a QR Code, characterized by comprising the following steps:
S1: setting a version of a to-be-defaced QR Code and an error correction grade, calculating the number of data code words and the number of error correction code words of the barcode under the conditions of the current version and the current error correction grade;
S2: setting the coding character type of the to-be-defaced QR Code, calculating the maximum number of characters capable of being coded using the current character type, which means that the number of bits of a data code word, after having added with the digits of a coded pattern indicator and the digits of a character counting indicator, is smaller than the number of the digits of a data code word under the conditions of the current version and correction grade; coding with the maximum number of characters to avoid the existence of filling characters in the data code word;
S3: generating the QR Code under the set conditions, dividing zones for various functional pattern modules and coding zone modules, wherein the modules include a data code word and error, correction code word module, a barcode boundary module, a position detection pattern module, a correction pattern module, a positioning pattern module, a version information module, and a format information module;
S4: performing quantitative defacing on various modules respectively, wherein the quantitative defacing includes data and error correction code word defacing, boundary defacing, position detection pattern defacing, correction pattern defacing, positioning pattern defacing, version information defacing, and format information defacing.

2. The method for quantitative defacing of a QR Code according to claim 1, wherein the number of characters used for coding, in patterns including number patterns, letter-number patterns, and 8-byte patterns, is required to be equal to the number of characters corresponding to a data code word which is specified by the current version and correction grade to avoid the situation of adding filling characters.

3. The method for quantitative defacing of a QR Code according to claim 2, wherein the coding pattern of the QR Code is analyzed; defacing of the data and error correction code words of the QR Code is quantified; 8 data bits of each one of the data code words and each one of the correction code words are randomly defaced; and when a reading error appears at any one or more of the 8 data bits, it is determined that a substitution error has occurred to the current data code word or error correction code word.

4. The method for quantitative defacing of a QR Code according to claim 3, wherein the number of substitution errors of the current QR Code corresponding to the current version and correction grade is queried to ensure that the defacing degree of the data and error correction code words does not exceed the capacity of the QR code for correcting the error code words.

5. The method for quantitative defacing of a QR Code according to claim 4, wherein the defacing of the data and error correction code words does not include defacing of the remaining bits of the QR Code.

6. The method for quantitative defacing of a QR Code according to claim 3, wherein the defacing rate of the data and error correction code words of the current QR Code is equal to the product of the defaced code word module/(the number of data correction words+the number of correction code words)*100%.

7. The method for quantitative defacing of a QR Code according to claim 1, wherein barcode boundary blank zones of the barcode boundary module respectively correspond to 0, 1, 2, 3, 4 unit(s) of module widths, and the defacing of the barcode boundary module is divided into a total of 5 grades.

8. The method for quantitative defacing of a QR Code according to claim 1, wherein defacing of the position detection pattern module includes defacing of a single position detection pattern in an upper left corner, defacing of a single position detection pattern in a lower left corner, defacing of a single position defection pattern in an upper right corner, and simultaneous defacing of two or three of the position detection patterns; defacing of the correction pattern module is classified into defacing of a single correction pattern and simultaneous defacing of multiple correction patterns according to the number of correction patterns of the QR Code; defacing of the positioning pattern module is classified into defacing of a vertical positioning pattern, defacing of a horizontal positioning pattern, and simultaneous defacing of two positioning patterns; defacing of the version information module is classified into defacing of version information in a lower left corner, defacing of version information in a lower right corner, and defacing of two pieces of version information; and defacing of the format version module is classified into defacing of format information at a lower left corner and an upper right corner, and defacing of format information at the left upper corner.

9. The method for quantitative defacing of a QR Code according to claim 1, wherein defacing of various modules simulates the actual defacing situations to the maximum extent, and the various modules are defaced in a way of completely contaminating various modules into light modules or dark modules of the barcode.

10. A system for quantitative defacing of a QR Code, characterized by comprising:
a barcode manufacturing module, used for manufacturing a barcode with the minimum anti-defacing capability; wherein the number of coding characters is equal to the maximum character number corresponding to a data code word which is defined by the version information, correction grade and coding characters of the barcode;
a barcode module zone dividing module, used for dividing module zones of the barcode to provide zone boundaries for quantitative defacing of various modules, wherein the modules include a data code word and error correction code word module, a barcode boundary module, a position detection pattern module, a correction pattern module, a positioning pattern module, a version information module, and a format information module;
a defacing pattern selection module, which provides pattern defacing options, namely a pre-stage printing defacing option and a rear-stage actual defacing option, wherein the pre-stage printing defacing refers to the operation of defacing a barcode when the barcode with the minimum anti-defacing capacity is manufactured and then printing the defaced barcode; the rear-stage actual, defacing refers to the operation of printing the barcode with the minimum anti-defacing capability and then defacing a specific module zone by controlling a doodling pen manually or with a mechanical arm;
a defacing module, used for defacing various modules, wherein the defacing includes data and error correction code word defacing, boundary defacing, position detection pattern defacing, correction pattern defacing, positioning pattern defacing, version information defacing, and format information defacing.

11. The method for quantitative defacing of a QR Code according to claim 9,
wherein the number of characters used for coding, in patterns including number patterns, letter-number patterns, and 8-byte patterns, is required to be equal to the number of characters corresponding to a data code word which is specified by the current version and correction grade to avoid the situation of adding filling characters;
wherein the coding pattern of the QR Code is analyzed; defacing of the data and error correction code words of the QR Code is quantified; 8 data bits of each one of the data code words and each one of the correction code words are randomly defaced; and when a reading error appears at any one or more of the 8 data bits, it is determined that a substitution error has occurred to the current data code word or error correction code word.

12. The method for quantitative defacing of a QR Code according to claim 9, wherein barcode boundary blank zones of the barcode boundary module respectively correspond to 0, 1, 2, 3, 4 unit(s) of module widths, and the defacing of the barcode boundary module is divided into a total of 5 grades.

13. The method for quantitative defacing of a QR Code according to claim 9, wherein defacing of the position detection pattern module includes defacing of a single position detection pattern in an upper left corner, defacing of a single position detection pattern in a lower left corner, defacing of a single position defection pattern in an upper right corner, and simultaneous defacing of two or three of the position detection patterns; defacing of the correction pattern module is classified into defacing of a single correction pattern and simultaneous defacing of multiple correction patterns, according to the number of correction patterns of the QR Code; defacing of the positioning pattern module is classified into defacing of a vertical positioning pattern, defacing of a horizontal positioning pattern, and simultaneous defacing of two positioning patterns; defacing of the version information module is classified into defacing of version information in a lower left corner, defacing of version information in a lower right corner, and defacing of two pieces of version information; and defacing of the format version module is classified into defacing of format information at a lower left corner and an upper right corner, and defacing of format information at the left upper corner.
